(19) United States
(12) Patent Application Publication
(10) Pub. No.: US 2008/0015321 A1
(43) Pub. Date: Jan. 17, 2008

(54) Non-Blocking Solid Resins Of Vinyl Ester Mixed Polymers

(75) Inventors: Kurt Stark, Weilersbach (DE); Andreas Lumpp, Sao Paulo, S.P. (BR); Christian Hogl, Reut (DE)

Correspondence Address: BROOKS KUSHMAN P.C., 1000 TOWN CENTER, TWENTY-SECOND FLOOR, SOUTHFIELD, MI, 48075, US

(73) Assignee: WACKER POLYMER SYSTEMS GMBH & CO. KG, Burghausen (DE)

(21) Appl. No.: 11/569,378

(22) PCT Filed: May 18, 2005
(86) PCT No.: PCT/EP05/05413

§ 371 Date: Nov. 20, 2006

(30) Foreign Application Priority Data
Jun. 1, 2004 (DE) 10 2004 026 608.5

(51) Int. Cl. C08F 120/06; C08F 10/00; C08F 120/10; C08F 220/44

(52) U.S. Cl. 526/318; 526/317.1; 526/318.6; 526/342

(57) ABSTRACT

Non-blocking solid vinyl ester copolymer resins have at least two different glass transition temperatures and are prepared by free-radical bulk or solution polymerization of
1. a) 50% to 97 % by weight of one or more comonomers M₁ selected from vinyl esters of optionally branched C₁₋₁₅ alkylcarboxylic acids and optionally alpha-olefin(s), monomers M₁ producing homopolymers with a Tg<40° C., with
   b) 3% to 50% by weight of one or more comonomers M₂ selected from vinylaromatics, (meth)acrylic acid and esters or amides thereof, and acrylonitrile, the comonomers M₂ producing homopolymers having a Tg>50° C.,
      wherein respecting the copolymerization of comonomers M₁ with comonomers M₂, the copolymerization parameters r₁<0.2 and r₂>2.0, and
      wherein some or all of comonomers M₂, and at least 3% by weight are introduced before the start of the polymerization.

The invention relates to non-blocking solid resins of vinyl ester copolymers, to processes for preparing them and to their use.

Solid resins of vinyl ester polymers or particularly of vinyl ester-ethylene copolymers tend frequently towards blocking. It is known from EP-A 959114 that the surface tackiness of vinyl ester-ethylene copolymers can be reduced by copolymerization with propylene. In addition it is known that silicones have good release properties, i.e. a surface that is repellent to sticky substances. Blends of solid vinyl ester resins with silicones, however, have unsatisfactory properties: owing to the incompatibility of vinyl ester polymer with silicone, phase separation occurs, and/or silicone domains are formed, and hence the solid resins become hazy. The formation of silicone domains and the presence of unbonded silicone leads, furthermore, to migration effects. WO 03/085035 A1 discloses a process whereby non-blocking solid resins based on vinyl ester polymers with silicone fractions are obtained.

The object on which the invention was based was to provide solid resins based on polyvinyl ester which, while avoiding the copolymerization of silicone fractions, have no blocking tendency and, moreover, exhibit no phase separation in organic solvents.

Surprisingly this has been achieved by copolymerizing vinyl esters with comonomers to give copolymers having at least two different glass transition stages. Surprisingly, because EP 381122 A2 describes how the copolymerization of comonomers incompatible with vinyl acetate, such as methyl methacrylate, leads to no improvement in blocking resistance; and in DE 4142104 A1 it is taught that the copolymerization of vinyl acetate and acrylic acid cannot be carried out commercially, and leads to products having highly deleterious properties, since inhomogeneities and phase separation occur with such copolymers.

The invention provides non-blocking solid resins based on vinyl ester copolymers, having at least two different glass transition stages, obtainable by means of free-radical polymerization in bulk or solution of
a) 50% to 97% by weight, based on the total amount of the comonomers M₁ and M₂, of one or more comonomers M₁ from the group consisting of vinyl esters of branched or of unbranched alkylcarboxylic acids having 1 to 15 carbon atoms, and, if desired, one or more alpha-olefins, the monomers M₁ leading to homopolymers having a glass transition temperature Tg<40° C., with
b) 3% to 50% by weight, based on the total amount of the comonomers M₁ and M₂, of one or more comonomers M₂ from the group consisting of vinylaromatics, (meth)acrylic acid and esters thereof or amides thereof or acrylonitrile, the comonomers M₂ leading to homopolymers having a glass transition temperature Tg>50° C., and
c) for the copolymerization of the comonomers M₁ with the comonomers M₂ the copolymerization parameters amount to r₁<0.2 and r₂>2.0, and
d) some or all of the comonomers M₂, and an amount of at least 3% by weight, based on the total amount of the comonomers M₁ and M₂, are introduced before the start of the polymerization.

Preferred vinyl esters M₁ are vinyl acetate, vinyl propionate, vinyl butyrate, vinyl-2-ethylhexanoate, vinyl laurate, 1-methylvinyl acetate, vinyl pivalate and vinyl esters of α-branched monocarboxylic acids having 5 to 11 carbon atoms, examples being VeoVa9^{R} or VeoVa10^{R} (trade names of Shell, (vinyl esters of α-branched monocarboxylic acids having 9 or 10 carbon atoms)). Vinyl acetate is particularly preferred. Preferred olefins are ethylene and propylene. Ethylene is particularly preferred.

In general the vinyl ester fraction as a proportion of the comonomers M₁ is 70% to 100% by weight, based on the total weight of the comonomers M₁. As comonomer M₁ it is preferred to use vinyl acetate or a mixture of vinyl acetate with 1% to 30% by weight of ethylene, based on the total weight of the comonomers M₁.

Preferred comonomers M₂ are acrylic acid and methacrylic acid, and also esters of acrylic and methacrylic acid with straight-chain or branched alcohols having 1 to 15 carbon atoms, and also acrylamide and methacrylamide, it also being possible for the ester or amide radical to contain functional or charged groups, the preferred comonomers M₂ each leading to homopolymers having a glass transition temperature Tg>50° C. Suitable functional and charged groups are hydroxyl, hydroxyalkyl, sulphonate, carboxyl, glycidyl, silane and ammonium groups. Particular preference is given to styrene, acrylic acid, methacrylic acid, methyl methacrylate (MMA), glycidyl methacrylate (GMA), acrylamide, N,N-dimethylacrylamide, acrylonitrile, 3-methacryloyloxypropyltrimethoxysilane, methacryloyloxymethyltrimethoxysilane, 2-acrylamido-2-methylpropanesulphonic acid (AMPS) and N-methylolacrylamide (NMA). Acrylic acid, methacrylic acid and methyl methacrylate are most preferred. The amount of comonomer M₂ is preferably 3% to 40% by weight, based on the total amount of the comonomers M₁ and M₂. The copolymerization parameters r₁ and r₂ are variables which are characteristic for each monomer pairing M₁ and M₂ and are known from the literature: for example, from J. Brandrup et al., Polymer Handbook.

Besides the monomers M₁ and M₂ it is also possible if desired to use one or more further, auxiliary monomers from the group consisting of (meth)acrylic esters of alcohols having 1 to 15 carbon atoms, whose homopolymers have a Tg of less than 50° C., and dienes and vinyl halides. Preferred (meth)acrylic esters are methyl acrylate, ethyl acrylate, propyl acrylate, n-, iso- and t-butyl acrylate and 2-ethylhexyl acrylate. Particular preference is given to methyl acrylate, n-, iso- and t-butyl acrylate and 2-ethylhexyl acrylate. Suitable dienes are 1,3-butadiene and isoprene. From the group of the vinyl halides it is usual to use vinyl chloride, vinylidene chloride or vinyl fluoride, preferably vinyl chloride.

Further examples of auxiliary monomers are ethylenically unsaturated monocarboxylic and dicarboxylic acids, preferably crotonic acid, fumaric acid and maleic acid; further ethylenically unsaturated carboxamides and carbonitriles, preferably N-vinyl-formamide; further, cyclic amides which carry an unsaturated group on the nitrogen, such as N-vinyl-pyrrolidone; monoesters and diesters of fumaric acid and maleic acid, such as the diethyl and diisopropyl esters, and also maleic anhydride; ethylenically unsaturated sulphonic acids and their salts, preferably vinylsulphonic acid. Further suitable auxiliary monomers include cationic monomers such as diallyl-dimethylammonium chloride (DADMAC), 3-trimethylammonio-propyl(meth)acrylamide chloride (MAPTAC) and 2-trimethylammonioethyl(meth)acrylate chloride. Further suitable auxiliary monomers include vinyl ethers and vinyl ketones.

Additional suitable auxiliary monomers include polymerizable silanes and/or mercaptosilanes. Those preferred include γ-acryloyloxy- and γ-methacryloyloxy-propyltri(alkoxy)silanes, α-methacryloyloxymethyltri-(alkoxy)silanes, γ-methacryloyloxypropylmethyldi-(alkoxy)silanes, vinylalkyldi(alkoxy)silanes and vinyl-tri(alkoxy)silanes, the alkoxy groups that can be used being, for example, methoxy, ethoxy, methoxyethylene, ethoxyethylene, methoxypropylene glycol ether and ethoxypropylene glycol ether radicals. Examples of such auxiliary monomers include vinyltrimethoxysilane, vinyltriethoxysilane, vinyltripropoxysilane, vinyltriisopropoxysilane, vinyltris(1-methoxy)isopropoxysilane, vinyltributoxysilane, vinyltriacetoxysilane, 3-methacryloxypropyltrimethoxysilane, 3-methacryloyloxypropylmethyldimethoxysilane, methacryloyloxymethyltrimethoxysilane, 3-methacryloyloxypropyltris(2-methoxyethoxy)silane, vinyltrichorosilane, vinylmethyldichlorosilane, vinyltris(2-methoxyethoxy)silane, tris-acetoxyvinylsilane, and 3-(triethoxysilyl)propyl-succinic anhydride-silane. Preference is also given to 3-mercaptopropyltriethoxysilane, 3-mercaptopropyltrimethoxysilane and 3-mercaptopropylmethyldimethoxysilane.

Further examples are functionalized acrylates and functionalized vinyl ethers and allyl ethers, especially epoxy-functional ones such as glycidyl acrylate, allyl glycidyl ether and vinyl glycidyl ether; or hydroxyalkyl-functional acrylates such as hydroxyethyl acrylate, or substituted or unsubstituted aminoalkyl acrylates.

Further examples are precrosslinking comonomers such as polyethylenically unsaturated comonomers, examples being divinyl adipate, diallyl maleate, allyl methacrylate, butanediol diacrylate or triallyl cyanurate, or postcrosslinking comonomers, examples being acrylamidoglycolic acid (AGA), methylacrylamidoglycolic acid methyl ester (MAGME), N-methylolacrylamide (NMA), N-methylolmethacrylamide, N-methylolallyl carbamate, alkyl ethers such as the isobutoxy ether or esters of N-methylolacrylamide, of N-methylolmethacrylamide and of N-methylolallyl carbamate.

The fraction of these auxiliary monomers is 0% to 30% by weight, based on the total amount of comonomers M₁ and M₂.

The solid resins are prepared by the bulk polymerization or solution polymerization process, preferably by means of solution polymerization. In the case of solution polymerization the medium employed is generally an alcoholic solution. Preferred solvents are methanol, ethanol, tert-butanol, ethyl acetate, acetone, methyl ethyl ketone, methyl acetate and iso-propanol, although mixtures of different solvents may also be used. The reaction is generally carried out under reflux conditions, generally at a polymerization temperature of 30° C. to 140° C., in order to utilize evaporative cooling to dissipate the heat of reaction. This may take place under atmospheric pressure or else under a slight superatmospheric pressure. When copolymerizing gaseous comonomers such as ethylene or vinyl chloride it is also possible to operate at higher pressures, generally 1 to 100 bar.

Initiators used are organic peroxides or azo compounds. Examples of those suitable include diacyl peroxides such as dilauroyl peroxide, peroxo esters such as t-butyl peroxopivalate, t-butyl perneodecanoate or t-butyl peroxo-2-ethylhexanoate, hydroperoxides such as t-butyl hydroperoxide, or peroxodicarbonates such as diethyl peroxodicarbonate, or azo initiators such as AIBN. The amount of initiator is generally 0.01% to 5.0% by weight, based on the monomers. The initiators may be both included in the initial charge and be metered in. It has been found appropriate to include some of the amount of initiator required in the initial charge and to meter in the remainder continuously during the reaction. The portion which is included in the initial charge depends on the extent to which the monomers are included in the initial charge. It may be an advantage to meter in initiators which decompose at different rates at different times during the reaction: a slowly decomposing initiator at the beginning and an initiator which decomposes at a higher temperature at the end of the reaction, where appropriate under elevated pressure.

Some or all of the comonomers M₁ can be introduced before the start of the polymerization; by the start of the polymerization is meant the point in time at which the batch is heated to polymerization temperature in the presence of initiator. It is preferred to include 5% to 60% by weight of the comonomers M₁ in the initial charge, based on the total amount of the comonomers M₁ and M₂, and to meter in the remainder. Some or all of the comonomers M₂, and an amount of at least 3% by weight, based on the total amount of the comonomers M₁ and M₂, is included in the initial charge. Preferably 3% to 30% by weight of the comonomers M₂, based on the total amount of comonomers M₁ and M₂, are included in the initial charge, so that the resultant resin is stable to blocking. With particular preference 3% to 20% by weight of the comonomers M₂, based on the total amount of the comonomers M₁ and M₂, is included in the initial charge, and the remainder is metered in. Most preferably 5% to 10% by weight of the comonomers M₂, based on the total amount of the comonomers M₁ and M₂, is included in the initial charge, and the remainder is metered in.

The reaction is started by means of an increase in temperature and, where appropriate, addition of initiator. At the end of the exothermic reaction it is preferred to remove the residual free monomers, the regulator and, where necessary, the solvent by distillation. In order to obtain very low VOC content the internal temperature is increased to levels of between 70° C. to 160° C. and subsequently a vacuum is applied.

The solid resins can be used in solid form or as a solution in organic solvent. They are suitable generally as binders, especially in coating materials, for example, and for producing adhesives, especially heat-sealable coatings and also laminating compositions. Further areas of application are as base materials for finishing agents and chewing-gum masses. The solid resins are also suitable for the low-profile sector, in the sound-damping sector (soundproofing), or as low-shrinkage additives. They can be used profitably in the coating or powder-coating sector, for coating wood, metals, plastics, e.g. films, or glass, for example. For the textile sector as well the resins are highly suitable. The resins can find advantageous use, moreover, in cosmetology, such as in hairsprays, or generally, in the hairstyling sector, for example.

Functional groups are introduced into the resin: for example, when functional monomers such as glycidyl methacrylate, N-methylolacrylamide, silane-containing monomers or acrylic acid are used, the resins can be crosslinked. In this case the resin may undergo crosslinking with itself, with the addition where appropriate of suitable catalysts, or else crosslinking mixtures of two different resins can be made, with one resin, for example, possessing a carboxylic acid function and the other resin an epoxide function.

In all cases the polyvinyl ester-based resins of the invention are distinguished by very high blocking stability, which brings considerable advantages particularly in connection with storage and transport. Where functional groups as well are present in the resins, the adhesion to certain substrates is enhanced as well.

The examples which follow serve to illustrate the invention further without restricting it in any way whatsoever.

### EXAMPLES

### Comparative Example 1

A 120 litre stirred tank (unpressurized) with reflux condenser, metering apparatus and an anchor stirrer was charged with 17.26 kg of methanol, 39.33 kg of vinyl acetate and 7.87 g of PPV (t-butyl perpivalate, 75% strength in aliphatics; half-life=1 h at 74° C.). The tank was heated to about 60° C. When a gentle reflux was reached, the initiator feed was commenced (70.8 g of PPV+3.93 kg of methanol). The initiator feed ran for 4 hours at a rate of 1000 g/h. After the initiator feed the batch ran at temperature for 60 minutes more. Following this after-reaction time the tank was heated for distillation, during which it was fed with fresh methanol every 30 minutes in accordance with the amount removed by distillation (demonomerization).

Solid Resin Analyses:

SC: 30.2%; viscosity (Höppler—10% strength in ethyl acetate in accordance with DIN 53015): 11.32 mPas; acid number (AN, methanol): 1.68 mg KOH/g; residual vinyl acetate: 470 ppm; K value 1% strength in acetone: 42.9; glass transition stage Tg: 39.1° C.

### Example 2

A 120 litre stirred tank (unpressurized) with reflux condenser, metering apparatus and an anchor stirrer was charged with 17.40 kg of methanol, 35.68 kg of vinyl acetate, 3.96 kg of acrylic acid and 7.93 g of PPV (t-butyl perpivalate, 75% strength in aliphatics; half-life=1 h at 74° C). The tank was heated to about 60° C. When a gentle reflux was reached, the initiator feed was commenced (71.36 g of PPV+3.96 kg of methanol). The initiator feed ran for 4 hours at a rate of 1010 g/h. After the initiator feed the batch ran at temperature for 60 minutes more. Following this after-reaction time the tank was heated for distillation, during which it was fed with fresh methanol every 30 minutes in accordance with the amount removed by distillation (demonomerization).

Solid Resin Analyses:

SC: 44.3%; AN (methanol): 84.15 mg KOH/g; residual vinyl acetate: 610 ppm; K value 1% strength in acetone: 42.4; glass transition stages Tg₁: 40.6° C., Tg₂: 93.3° C.

### Comparative Example 3

A 120 litre stirred tank (unpressurized) with reflux condenser, metering apparatus and an anchor stirrer was charged with 17.40 kg of methanol, 7.14 kg of vinyl acetate, 792.88 g of acrylic acid and 7.93 g of PPV (t-butyl perpivalate, 75% strength in aliphatics; half-life=1 h at 74° C.). The tank was heated to about 60° C. When a gentle reflux was reached, the initiator feed was commenced (71.36 g of PPV+3.96 kg of methanol). The initiator feed ran for 310 minutes at a rate of 782 g/h. 10 minutes after the commencement of the initiator feed the monomer feed began, with a rate of 7.93 kg/h. The monomer feed contained 28.54 kg of vinyl acetate and 3.17 kg of acrylic acid. The metering time for the monomer feed was 240 minutes. After the initiator feed the batch ran at temperature for 60 minutes more. Following this after-reaction time the tank was heated for distillation, during which it was fed with fresh methanol every 30 minutes in accordance with the amount removed by distillation (demonomerization).

Solid Resin Analyses:

SC: 29.5%; AN (methanol): 89.76 mg KOH/g; residual vinyl acetate: 250 ppm; K value 1% strength in acetone: 47.8; glass transition stages Tg₁: 39.9° C., Tg₂: 60.7° C.

### Example 4

A 120 litre stirred tank (unpressurized) with reflux condenser, metering apparatus and an anchor stirrer was charged with 17.40 kg of methanol, 17.84 kg of vinyl acetate, 1.98 kg of acrylic acid and 7.93 g of PPV (t-butyl perpivalate, 75% strength in aliphatics; half-life=1 h at 74° C.). The tank was heated to about 60° C. When a gentle reflux was reached, the initiator feed was commenced (71.36 g of PPV+3.96 kg of methanol). The initiator feed ran for 310 minutes at a rate of 782 g/h. 10 minutes after the commencement of the initiator feed the monomer feed began, with a rate of 4.96 kg/h (17.84 kg of vinyl acetate+1.98 kg of acrylic acid). The metering time for the monomer feed was 240 minutes. After the initiator feed the batch ran at temperature for 60 minutes more. Following this after-reaction time the tank was heated for distillation, during which it was fed with fresh methanol every 30 minutes in accordance with the amount removed by distillation (demonomerization).

Solid Resin Analyses:

SC: 38.5%; AN (methanol): 91.44 mg KOH/g; residual vinyl acetate: 270 ppm; K value 1% strength in acetone: 40.9; glass transition stages Tg₁: 40.3° C., Tg₂: 84.6° C.

### Example 5

A 120 litre stirred tank (unpressurized) with reflux condenser, metering apparatus and an anchor stirrer was charged with 17.53 kg of methanol, 15.98 kg of vinyl acetate, 4.00 kg of acrylic acid and 7.99 g of PPV (t-butyl perpivalate, 75% strength in aliphatics; half-life=1 h at 74° C.). The tank was heated to about 60° C. When a gentle reflux was reached, the initiator feed was commenced (71.93 g of PPV+4.00 kg of methanol). The initiator feed ran for 310 minutes at a rate of 788 g/h. 10 minutes after the commencement of the initiator feed the monomer feed began, with a rate of 5.0 kg/h (15.98 kg of vinyl acetate+4.00 kg of acrylic acid). The metering time for the monomer feed was 240 minutes. After the initiator feed the batch ran at temperature for 60 minutes more. Following this after-reaction time the tank was heated for distillation, during which it was fed with fresh methanol every 30 minutes in accordance with the amount removed by distillation (demonomerization).

Solid Resin Analyses:

SC: 41.5%; AN (methanol): 95.37 mg KOH/g; residual vinyl acetate: 800 ppm; K value 1% strength in acetone: 38.8; glass transition stages Tg₁: 41.8° C., Tg₂: 57.3° C., Tg₃: 98.0° C.

### Comparative Example 6

A standard commercial acid-functionalized solid resin from Wacker Polymer Systems with a K value of about 30, containing about 5% by weight of crotonic acid and about 95% by weight of polyvinyl acetate (brand name: Vinnapas® C305).

Performance Investigations:

Blocking Test:

To determine the blocking stability or blocking tendency the resins from the inventive and comparative examples were first ground to powders of comparable particle size. The powders were subsequently placed in a brass cup having an inside diameter of 49 mm and a height of 3 cm. The amount of pulverulent resin added was such that the brass cup was filled to about ⅓ of its capacity; that is, the powder stood to a height of about 1 cm in the cup. Thereafter a brass cylinder with a mass of 1 kg and a diameter of 47 mm was placed on the powder (with its surface level) in the brass cup. The apparatus was placed in a drying oven at 50° C. for 1 h. After this time the apparatus was removed from the drying oven and the cylinder was removed. The pressed powder in the brass cup was tested for its blocking using a spatula.

Assessment was made using the following grade system:

1: The powder is not blocked and can easily be divided with the spatula.

2: The powder has undergone minimal blocking but can still be divided readily with the spatula.

3: The powder has undergone slight blocking and can be divided with the spatula with a little effort.

4: The powder has undergone moderate blocking and can be divided with the spatula with greater effort.

5: The powder has undergone marked blocking and can be divided with the spatula only with very great effort.

6: The powder has undergone complete blocking (i.e., has plastified) and can no longer be divided with the spatula even with maximum effort.

TABLE 1
Blocking test conditions: 50° C./1 h/1 kg (powder)

| Example | Blocking test |
|---|---|
| Comparative Example 1 | 6 |
| Example 2 | 2 |
| Comparative Example 3 | 5 |
| Example 4 | 2 |
| Example 5 | 1 |
| Comparative Example 6 | 5 |

A similar result was obtained when the blocking test outlined above was carried out not with powders but instead with films produced from the resins from solution (e.g. in methanol).

In this case, 2 films of the resin, with dimensions of about 2 mm×2 mm, were placed on top of one another and placed inside the blocking apparatus, weighted with 2 kg (2 brass cylinders) and placed in the drying oven at 55° C. for 1 h. Thereafter the films were pulled apart by hand.

Evaluation According to the Following Grade System:

1: The films are not joined to one another and can be parted from one another easily.

2: The films are slightly joined to one another but can be parted from one another easily.

3: The films are markedly joined to one another but can be parted from one another with a fairly low effort.

4: The films are distinctly joined to one another but can be parted from one another with a relatively high effort.

5: The films are joined very strongly to one another and can be parted from one another only with a very high degree of effort.

6: The films are joined completely to one another (stuck to one another) and can no longer be parted from one another even with the greatest of effort.

TABLE 2
Blocking test conditions: 55° C./1 h/2 kg (films)

| Example | Blocking test |
|---|---|
| Comparative Example 1 | 5 |
| Example 2 | 2 |
| Comparative Example 3 | 4 |
| Example 4 | 2 |
| Example 5 | 1 |

From Table 1 it is apparent that the blocking stability of the resins in powder form is markedly increased by the introduction of hard monomers, in this case acrylic acid, by the process of the invention (Examples 2, 4 and 5). This effect comes about even with a small amount of hard monomer, above 3% or, here, 5% by weight in the resin, if it is included in the initial charge. A comparison of Examples 2 and 4 with Comparative Example 3 (all possess a total of 10% by weight of acrylic acid in the resin) shows that blocking-stable behaviour in the resins can only be achieved when a relatively large amount of hard monomer is included in the initial charge. Thus, in Comparative Example 3, with only 2% by weight of acrylic acid (based in each case on the total monomer amount) in the initial charge, a blocking evaluation of 5 is obtained (high blocking tendency), whereas in Example 4 (5% by weight of acrylic acid in the initial charge) and in Example 2 (10% by weight of acrylic acid in the initial charge) a blocking evaluation of 2 (very low blocking tendency) was obtained. In other words, despite the same amount of hard monomer, the process of polymerization (initial charge, metering) exerts the decisive effect on the blocking behaviour.

Under the investigation conditions, a resin without hard monomer exhibits complete blocking (blocking evaluation 6, Comparative Example 1). If, instead of a hard monomer which copolymerizes very poorly with vinyl acetate, the same amount is used of a hard monomer which copolymerizes significantly better with vinyl acetate, no improvement in blocking stability is achieved (Comparative Example 6, with crotonic acid instead of acrylic acid, blocking evaluation 5). This means that, in addition to the process of polymerization, the copolymerization parameters of the comonomers with respect to one another also play a decisive role in respect of the blocking tendency.

A similar result was found in the context of the performance measurements made on films of the resins from the inventive and comparative examples. Despite having had 2 or more glass transition stages Tg, all of the inventive resins showed no phase separation in organic solvent or in the melt. This behaviour as well can be achieved only with the polymerization process of the invention.

1-13. (canceled)

14. Non-blocking solid resins comprise vinyl ester copolymers having at least two different glass transition stages, prepared by free-radical polymerization, in bulk or solution, of monomers M₁ and M₂, wherein
a) 50% to 97% by weight, based on the total amount of comonomers M₁ and M₂, are one or more comonomers M₁ selected from the group consisting of vinyl esters of α-branched and unbranched alkylcarboxylic acids having 1 to 15 carbon atoms, and alpha-olefins, the monomers M₁ being those producing homopolymers having a glass transition temperature Tg<40° C., and comprising at least one vinyl ester comonomer, and
b) 3% to 50% by weight, based on the total amount of the comonomers M₁ and M₂, are one or more comonomers M₂ selected from the group consisting of vinylaromatics, (meth)acrylic acid, (meth)acrylic esters, (meth)acrylic amides, and acrylonitrile, the comonomers M₂ being those producing homopolymers having a glass transition temperature Tg>50° C.,
wherein with respect to the copolymerization of the comonomers M₁ with the comonomers M₂, the copolymerization parameters r₁ and r₂ fulfill the relationship amount to r₁<0.2 and r₂>2.0, and
wherein at least a portion of the comonomers M₂ and an amount of at least 3% by weight of comonomers M₂, based on the total amount of comonomers M₁ and M₂, are present before the start of the polymerization.

15. A process for the preparation of the non-blocking solid vinyl ester copolymer resin of claim 14 having at least two different glass transition stages, comprising free-radical polymerizing comonomers M₁ and M₂ in bulk or solution, wherein
a) 50% to 97% by weight, based on the total amount of comonomers M₁ and M₂, are one or more comonomers M₁ selected from the group consisting of vinyl esters of α-branched and unbranched alkylcarboxylic acids having 1 to 15 carbon atoms, and alpha-olefins, the monomers M₁ being those producing homopolymers having a glass transition temperature Tg<40° C., and comprising at least one vinyl ester comonomer, and
b) 3% to 50% by weight, based on the total amount of the comonomers M₁ and M2, are one or more comonomers M₂ selected from the group consisting of vinylaromatics, (meth)acrylic acid, (meth)acrylic esters, (meth)acrylic amides, and acrylonitrile, the comonomers M₂ being those producing homopolymers having a glass transition temperature Tg>50° C.,
wherein with respect to the copolymerization of the comonomers M₁ with the comonomers M₂, the copolymerization parameters r₁ and r₂ fulfill the relationship amount to r₁<0.2 and r₂>2.0, and
wherein at least a portion of the comonomers M₂ and an amount of at least 3% by weight of comonomers M₂, based on the total amount of comonomers M₁ and M₂, are present before the start of the polymerization.

16. The process of claim 15, wherein vinyl acetate or a mixture of vinyl acetate with 1% to 30% by weight of ethylene, based on the total weight of the comonomer M₁, is employed as comonomer M₁.

17. The process of claim 15, wherein one or more comonomers selected from the group consisting of acrylic acid and methacrylic acid, esters of (meth)acrylic acid with straight-chain or branched alcohols having 1 to 15 carbon atoms, acrylamide, and methacrylamide, the ester or amide radical optionally contain functional or charged groups, are used as comonomers M₂.

18. The process of claim 16, wherein one or more comonomers selected from the group consisting of acrylic acid and methacrylic acid, esters of (meth)acrylic acid with straight-chain or branched alcohols having 1 to 15 carbon atoms, acrylamide, and methacrylamide, the ester or amide radical optionally contain functional or charged groups, are used as comonomers M₂.

19. The process of claim 17, wherein one or more comonomers M₂ are selected from the group consisting of styrene, acrylic acid, methacrylic acid, methyl methacrylate, glycidyl methacrylate, acrylamide, N,N-dimethylacrylamide, acrylonitrile, 2-acrylamido-2-methylpropanesulphonic acid and N-methylolacrylamide.

20. The process of claim 15, wherein 5 to 60% by weight of the comonomers M₁, based on the total amount of the comonomers M₁ and M₂, is included in an initial charge, and the remainder is metered in.

21. The process of claim 16, wherein 5 to 60% by weight of the comonomers M₁, based on the total amount of the comonomers M₁ and M₂, is included in an initial charge, and the remainder is metered in.

22. The process of claim 17, wherein 5 to 60% by weight of the comonomers M₁, based on the total amount of the comonomers M₁ and M₂, is included in an initial charge, and the remainder is metered in.

23. The process of claim 18, wherein 5 to 60% by weight of the comonomers M₁, based on the total amount of the comonomers M₁ and M₂, is included in an initial charge, and the remainder is metered in.

24. The process of claim 19, wherein 5 to 60% by weight of the comonomers M₁, based on the total amount of the comonomers M₁ and M₂, is included in an initial charge, and the remainder is metered in.

25. The process of claim 15, wherein 3% to 30% by weight of the comonomers M₂, based on the total amount of the comonomers M₁ and M₂, is included as an initial charge and the remainder is metered in.

26. The process of claim 16, wherein 3% to 30% by weight of the comonomers M₂, based on the total amount of the comonomers M₁ and M₂, is included as an initial charge and the remainder is metered in.

27. The process of claim 17, wherein 3% to 30% by weight of the comonomers M₂, based on the total amount of the comonomers M₁ and M₂, is included as an initial charge and the remainder is metered in.

28. The process of claim 18, wherein 3% to 30% by weight of the comonomers M₂, based on the total amount of the comonomers M₁ and M₂, is included as an initial charge and the remainder is metered in.

29. The process of claim 19, wherein 3% to 30% by weight of the comonomers M₂, based on the total amount of the comonomers M₁ and M₂, is included as an initial charge and the remainder is metered in.

30. The process of claim 20, wherein 3% to 30% by weight of the comonomers M₂, based on the total amount of the comonomers M₁ and M₂, is included as an initial charge and the remainder is metered in.

31. The process of claim 15, further comprising incorporating the non-blocking vinyl ester copolymer into a coating, an adhesive, a finishing agent, a soundproofing additive, a low-shrinkage additive, a cosmetic composition, or chewing gum.

32. A non-blocking coating or film, comprising a non-blocking vinyl ester copolymer of claim 14.

33. A non-blocking coating or film, comprising a non-blocking vinyl ester copolymer prepared by the process of claim 15.
